(19) United States
(12) Patent Application Publication
(10) Pub. No.: US 2020/0088246 A1
(43) Pub. Date: Mar. 19, 2020

(54) THERMAL FUSE EMISSIVITY IMPROVEMENT

(71) Applicant: Hanon Systems, Daejeon (KR)

(72) Inventors: Tim Ewan, Novi, MI (US); Mark Honkala, Howell, MI (US); Steve White, Pinckney, MI (US)

(21) Appl. No.: 16/244,539

(22) Filed: Jan. 10, 2019

Related U.S. Application Data
(60) Provisional application No. 62/731,352, filed on Sep. 14, 2018.

(51) Int. Cl. F16D 27/112; F16D 27/14; F16D 9/02

(52) U.S. Cl. CPC F16D 27/112; F16D 2027/001; F16D 9/02; F16D 27/14

(57) ABSTRACT

A thermal fuse includes a casing wall configured to transfer heat energy generated exterior to the casing wall to a thermally activated device disposed in an interior of the casing wall. The thermally activated device is configured for activation at a preselected temperature. The casing wall includes a coating layer disposed on an adjacent layer. The coating layer forms an outermost surface of the casing wall and has an emissivity greater than the adjacent layer of the casing wall.

### CROSS-REFERENCE TO RELATED APPLICATIONS

This patent application claims priority to U.S. Provisional Patent Application No. 62/731,352 filed on Sep. 14, 2018, the entire disclosure of which is hereby incorporated herein by reference in its entirety.

### FIELD OF THE INVENTION

The invention relates to an electromagnetic clutch assembly, and more particularly to a thermal fuse of the electromagnetic clutch assembly.

### BACKGROUND OF THE INVENTION

Automobiles commonly include several components that are driven by transmission of a torque from an output shaft of an engine (or other driving mechanism) to the desired vehicle components. In order to prevent inefficient operation of the automobile, it is often desirable to transmit the torque to the components only when the operation thereof is required by the automobile or when the use is desirable to a passenger in the automobile. Such a component may be a compressor forming a component of a heating, ventilating, and air conditioning (HVAC) system of the automobile, as use of the compressor may be dependent on the desire of the user and the conditions of the ambient environment. Accordingly, an electromagnetic clutch assembly may be used to selectively transmit the torque from the automobile engine to the compressor.

FIG. 1 illustrates a cross-sectional view of a common configuration of an electromagnetic clutch assembly 1 for use with a compressor (not shown), wherein the electromagnetic clutch assembly 1 is configured as a portion of an automobile HVAC system. The electromagnetic clutch assembly 1 includes a pulley 2, a clutch disc 3, and an electromagnetic coil 5. The pulley 2 may normally be rotated about a central axis thereof by means of a drive belt (not shown) mechanically coupled to the output shaft of the engine, including when the compressor is not in use. When the compressor is not in use, a gap is present between the pulley 2 and the clutch disc 3, wherein the gap may be maintained via use of a biasing device that normally biases the clutch disc 3 in a direction away from the pulley 2. When it is desirable for the compressor to operate, such as when cool air is desired within a passenger compartment of the automobile, the electromagnetic coil 5 is energized in a manner wherein an electromagnetic force attracts the clutch disc 3 towards the pulley 2 to eliminate the gap present therebetween. The clutch disc 3 then engages the pulley 2 to transfer power from the drive belt to the clutch disc 3. The clutch disc 3 includes a shaft coupling portion 4 configured for coupling to a torque transferring shaft (not shown) associated with driving the internal components of the associated compressor. The engagement between the clutch disc 3 and the pulley 2 preferably occurs without any relative motion therebetween in order to efficiently transfer the power of the engine to the internal components of the compressor.

However, under certain circumstances, an occurrence of “clutch slip” may occur between the clutch disc 3 and the pulley 2 of the electromagnetic clutch assembly 1. Clutch slip refers to an incidence of relative rotational motion present between the clutch disc 3 and the pulley 2 despite the frictional engagement therebetween. Such a condition may occur when the compressor associated with the electromagnetic clutch assembly 1 seizes, which in turn causes the clutch disc 3 to maintain a rotational position thereof while the pulley 2 continues to rotate via the driving of the associated drive belt. An extended period of clutch slip can lead to damage to an associated pulley bearing, which in turn can lead to a loss of drive belt function in a manner also negatively affecting performance of the engine.

Frictional forces caused by the relative motion between the clutch disc 3 and the pulley 2 during the clutch slip condition lead to the generation of heat. As such, one method of monitoring for an incidence of clutch slip in the electromagnetic clutch assembly 1 includes monitoring a temperature at or adjacent the point of engagement between the clutch disc 3 and the pulley 2. The temperature is monitored in order to determine if the temperature has increased to an extent indicating that a period of clutch slip has occurred.

For example, one solution includes the implementation of a thermal fuse that is configured to activate when a temperature of the thermal fuse is increased to a preselected temperature value. The thermal fuse may include an internally disposed pellet that is configured to melt when exposed to the preselected temperature, wherein the melting of the pellet leads to a reconfiguration of the internal components of the thermal fuse in a manner causing an open circuit condition within the thermal fuse. Upon activation of the thermal fuse, the open circuit condition is communicated to the electromagnetic coil 5 in order to disengage the clutch disc 3 from the pulley 2, thereby ending the relative rotational motion and friction therebetween. The thermal fuse may be disposed at any position adjacent the engagement between the clutch disc 3 and the pulley 2, including on an exposed face of a housing of the electromagnetic coil 5 facing towards the clutch disc 3 as shown in FIGS. 1 and 2.

However, such thermal fuses typically require a clutch slip condition to occur for an extended period of time in order for the thermal fuse to be activated, thereby presenting an opportunity for the pulley bearing to become damaged while the temperature adjacent the thermal fuse has yet to reach the preselected temperature value activating the thermal fuse. For example, such thermal fuses may require about three minutes of continuous clutch slip when the engine of the associated vehicle is idling with an ambient environment at room temperature for the thermal fuse to be thermally activated.

FIGS. 1 and 2 illustrate an embodiment of a thermal fuse 100 as described hereinabove, wherein the thermal fuse 100 is positioned on a face of the housing of the electromagnetic coil 5 facing towards the clutch disc 3. The thermal fuse 100 includes a casing wall 102 forming an outer surface of the thermal fuse 100 in heat exchange relationship with the heat generated as a result of the clutch slip condition. As shown in FIG. 3, which illustrates a sectional view of the casing wall 102, the casing wall 102 may include a base layer 104 formed from a base metal such as brass. The base layer 104 may be optionally coated with a first underplating layer 106 disposed on a surface of the base layer 104 facing towards an exterior of the thermal fuse 100 and a second underplating layer 108 formed on an opposing surface of the base layer 104 facing towards an interior of the thermal fuse 100. The first underplating layer 106 is coated with a first top plating layer 112 and the second underplating layer 108 is coated with a second top plating layer 114. Each of the top plating layers 112, 114 may be formed from a material having a reflective metallic appearance. The top plating layers 112, 114 may be formed from a layer of silver, gold, platinum, or tin, as non-limiting examples. The first top plating layer 112 forms an outermost surface of the thermal fuse 100 exposed to the ambient environment, hence any heat energy transferred to the thermal fuse 100 must first pass through the first top plating layer 112.

It has been discovered that the bright metallic appearance of the first top plating layer 112 may cause a time delay in activating the thermal fuse 100 following an occurrence of the clutch slip condition. The relatively slow reaction time occurs because the bright metallic finish of the first top plating layer 112 typically includes a relatively low emissivity (generally <0.1 on a 0.0-1.0 scale), which indicates that the top plating layer 112 of the thermal fuse 100 is not well suited for absorbing any incoming thermal (infrared) radiation generated by the frictional forces present between the clutch disc 3 and the pulley 2. As a result, the casing wall 102 is primarily heated only by conductive heat transfer and convective heat transfer, which results in the internal components of the thermal fuse 100 being heated to the desired triggering temperature at a much slower speed than could be realized if the thermal fuse 100 were configured to more readily receive the thermal radiation generated by the clutch slip condition.

It would therefore be desirable to produce a thermally activated fuse having a heat exchange surface with relatively high emissivity in order to quickly and accurately determine that the clutch slip condition has occurred with respect to all possible clutch slip conditions.

### SUMMARY OF THE INVENTION

Compatible and attuned with the present invention, a thermally activated fuse with a high emissivity surface for increasing heat transfer efficiency through thermal radiation has surprisingly been discovered.

In one embodiment of the invention, a thermal fuse comprises a casing wall configured to transfer heat energy generated exterior to the casing wall to a thermally activated device disposed in an interior of the casing wall. The thermally activated device is configured for activation at a preselected temperature. The casing wall includes a coating layer disposed on an adjacent layer. The coating layer forms an outermost surface of the casing wall and has an emissivity greater than the adjacent layer of the casing wall.

In another embodiment of the invention, an electromagnetic clutch assembly is disclosed. The electromagnetic clutch assembly comprises a pulley, a clutch disc configured to selectively engage the pulley, and a thermal fuse. The thermal fuse includes a casing wall configured to transfer heat generated exterior to the casing wall as a result of relative frictional motion between the pulley and the clutch disc to an interior of the casing wall. The casing wall includes a coating layer disposed on an adjacent layer. The coating layer forms an outermost surface of the casing wall and has an emissivity greater than the adjacent layer of the casing wall.

A method of manufacturing a thermal fuse is also disclosed. The method of comprises the steps of: providing a thermal fuse having a casing wall including an outermost layer, the casing wall configured to transfer heat generated exterior to the casing wall to a thermally activated device disposed in an interior of the casing wall; and forming or depositing a coating layer on the outermost layer of the casing wall, the coating layer having an emissivity greater than the outermost layer of the casing wall.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings:

FIG. 1 is a cross-sectional elevational view of an electromagnetic clutch assembly according to the prior art;

FIG. 2 is perspective view of an electromagnetic coil housing having a thermal fuse according to the prior art;

FIG. 3 is an enlarged fragmentary cross-sectional view of a casing wall of the thermal fuse according to the prior art;

FIG. 4 is a cross-sectional elevational view of a thermal fuse prior to activation thereof according to an embodiment of the present invention;

FIG. 5 is an enlarged cross-sectional view of the area bounded by the circle in FIG. 4; and

FIG. 6 is a cross-sectional elevational view of the thermal fuse of FIG. 4 following activation thereof.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

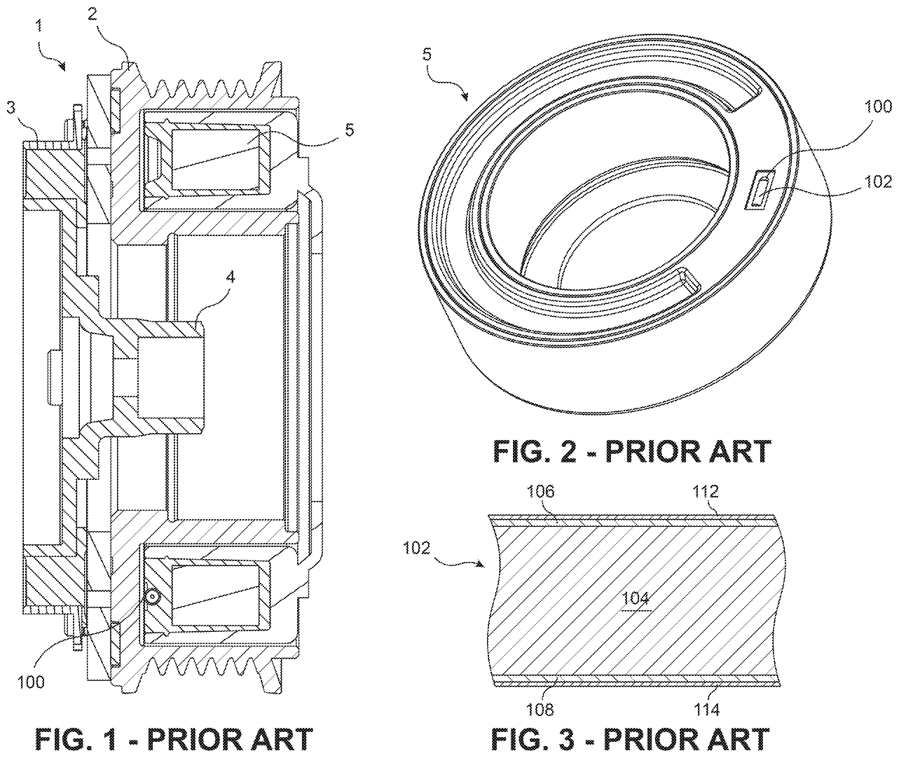

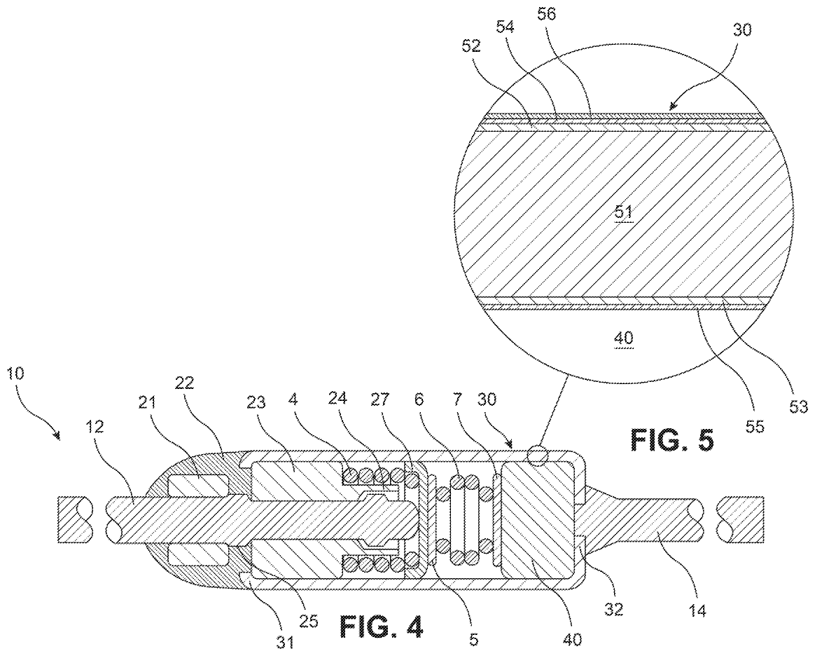

FIGS. 4-6 illustrate an exemplary thermal fuse 10 according to an embodiment of the invention. The thermal fuse 10 forms a portion of an electromagnetic clutch assembly associated with the operation of a rotary component such as a driving shaft of a compressor of a motor vehicle. The thermal fuse 10 is configured to detect a clutch slip condition of the associated electromagnetic clutch assembly. The thermal fuse 10 may be disposed at any suitable position relative to the electromagnetic clutch assembly for detecting the heat generated by the clutch slip condition. The thermal fuse 10 may be positioned on a face of a housing of an electromagnetic coil of the electromagnetic clutch assembly adjacent the engagement between a clutch disc and a pulley of the electromagnetic clutch assembly. For example, with reference to the electromagnetic clutch assembly 1 illustrated in FIG. 1, the thermal fuse 100 may be replaced by the thermal fuse 10, thereby placing the thermal fuse 10 on a face of the housing of the electromagnetic coil 5 facing towards the engaging surface of the clutch disc 3. However, it should be understood that the thermal fuse 10 may be placed at any position adjacent the engagement between a clutch disc and a pulley of the corresponding electromagnetic clutch assembly for detecting the heat generated by the clutch slip condition. The thermal fuse 10 may be disposed at a position relative to the corresponding electromagnetic clutch assembly suitable for maximizing the heat transfer to the thermal fuse 10 following the clutch slip condition. The optimal position for the thermal fuse 10 may be determined by discovering a position of the thermal fuse 10 allowing the thermal fuse 10 to receive heat energy via each of conductive heat transfer through the adjacent components forming the electromagnetic clutch assembly, convective heat transfer through the air passing over the electromagnetic clutch assembly, and any thermal radiation emitted by the clutch disc or the pulley as a result of the frictional forces present during the clutch slip condition.

The thermal fuse 10 is configured to be activated when at least a portion of the thermal fuse 10 reaches a preselected temperature indicative of the presence of the clutch slip condition of the associated electromagnetic clutch assembly. As used herein, the thermal fuse 10 being activated refers to a state of the thermal fuse 10 wherein the thermal fuse 10 no longer allows an electrical current to pass therethrough. Prior to the activation, it is assumed that a current is normally capable of passing through the thermal fuse 10 when the associated electrical system is electrically energized.

The thermal fuse 10 may form a component of a circuit used to energize the coil of the electromagnetic clutch assembly. The activation of the thermal fuse 10 may cause a current normally passing through the thermal fuse 10 and energizing the electromagnetic coil to be discontinued. The discontinuing of the current causes the coil of the electromagnetic clutch assembly to also no longer be energized, thereby ceasing the frictional contact present between the clutch disc and the pulley as a gap is formed therebetween following the discontinuing of the electrical current. The thermal fuse 10 may alternatively be referred to as a thermally activated circuit breaker, as desired, without departing from the scope of the present invention.

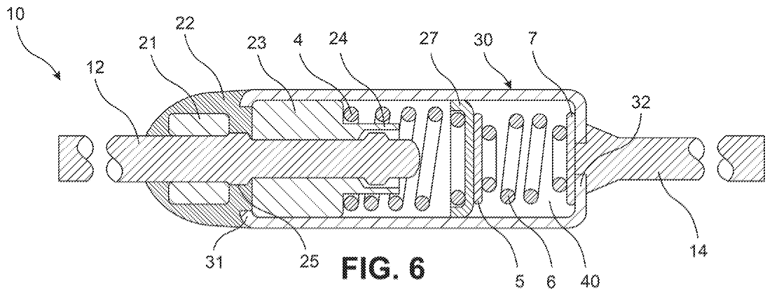

The thermal fuse 10 may include substantially any internal structure suitable for discontinuing the passage of the current therethrough. As such, the internal structure of the thermal fuse 10 as shown and described with reference to FIGS. 4 and 6 is merely illustrative of one potential triggering mechanism for the thermal fuse 10, and should not be considered limiting as to the mechanisms capable of carrying out the general concepts of the present invention.

The thermal fuse 10 as disclosed in FIGS. 4 and 6 includes a first lead 12 disposed at a first end thereof and a second lead 14 disposed at a second end thereof. The first lead 12 may be in electrical communication with a power source of the associated electrical circuit while the second lead 14 may be in electrical communication with the coil of the electromagnetic clutch assembly. The first lead 12 extends in a longitudinal direction of the thermal fuse 10 while passing through each of a cylindrical first bushing 21, a cylindrical sealing structure 22, and a cylindrical second bushing 23, each of which is formed from a substantially electrically non-conductive material. The first bushing 21 and the second bushing 23 may each be formed from a ceramic material, whereas the cylindrical sealing structure 22 may be formed from a moldable sealing resin, as desired. The first lead 12 includes an annular projection 25 disposed between the first bushing 21 and the second bushing 23 for affixing an axial position of the first lead 12.

A cylindrical casing wall 30 of the thermal fuse 10 extends longitudinally from a first end 31 to a second end 32 thereof. In the illustrated embodiment, the first end 31 of the casing wall 30 is flared radially inwardly around an end of the second bushing 23 while the second end 32 of the casing wall 30 is flared radially inwardly between an outwardly flared portion of the second lead 14 and a thermal pellet 40 disposed within the casing wall 30. The casing wall 30 forms an outermost portion of the thermal fuse 10 configured for transferring heat generated outside of the casing wall 30 to the components of the thermal fuse 10 disposed inside of the casing wall 30.

The thermal fuse 10 illustrated in FIGS. 4 and 6 includes an electrically conductive casing wall 30. More specifically, at least an innermost surface of the casing wall 30 is electrically conductive for carrying the electrical current passing through the thermal fuse 10, as explained in greater detail hereinafter.

The second bushing 23 includes an axially extending small diameter portion 24 having an outer circumferential surface facing towards an innermost surface of the casing wall 30. A first spring element 4 is disposed between the innermost surface of the casing wall 30 and the outer circumferential surface of the small diameter portion 24. A first end of the first spring element 4 contacts a radially extending surface of the second bushing 23 from which the small diameter portion 24 projects while a second end of the first spring element 4 contacts a slider mechanism 27 slidably disposed within casing wall 30 and formed from an electrically conductive material. The slider mechanism 27 includes an outer circumferential surface in contact with the innermost surface of the casing wall 30.

The thermal fuse 10 further includes a first disk 5, a second spring element 6, and a second disk 7. The first disk 5 is in contact with the slider mechanism 27, the second spring element 6 is disposed between and contacts each of the first disk 5 and the second disk 7, and the second disk 7 contacts the thermal pellet 40. As shown in FIG. 4, the first spring element 4 and the second spring element 6 are normally in a compressed state prior to activation of the thermal fuse 10. Furthermore, when in the compressed state shown in FIG. 4 a spring force provided by the second element 6 is greater than a spring force provided by the first spring element 4 to cause the slider mechanism 27 to normally be placed in contact with an end of the first lead 12. The continuous contact between the first lead 12 and the slider mechanism 27 allows for the current carried through the thermal fuse 10 to pass in order through the first lead 12, the slider mechanism 27, the casing wall 30, and the second lead 14.

As shown in FIG. 5, the casing wall 30 includes a plurality of layers in a thickness direction of the casing wall 30. In all cases, at least a portion of the casing wall 30 includes a combination of a base layer 51 and a coating layer 56. The coating layer 56 may be disposed directly on the base layer 51 or the coating layer 56 may be disposed on an intervening layer of the casing wall 30 disposed between the coating layer 56 and the base layer 51, as shown and described herein with reference to the embodiment illustrated in FIG. 5.

The coating layer 56 forms an outermost surface of the casing wall 30 exposed to the ambient environment surrounding the thermal fuse 10. The coating layer 56 may be in fluid communication with a supply of air passing over or through the electromagnetic clutch assembly housing the thermal fuse 10. A portion of the coating layer 56 may be in contact with one or more components of the electromagnetic clutch assembly, such as the coil to which the thermal fuse 10 may be mounted as shown with reference to FIG. 1. Lastly, at least a portion of the coating layer 56 may be exposed and in facing relationship with a portion of the clutch disc or the pulley generating the thermal radiation during the clutch slip condition. In some embodiments, an entirety of the casing wall 30 includes the coating layer 56. In other embodiments, only those portions of the casing wall 30 exposed directly to the ambient environment (such as a side of the thermal fuse opposite the face of the coil to which the thermal fuse is mounted) may include the coating layer 56.

In the provided example, the casing wall 30 includes each of the base layer 51, an outer under-plating layer 52, an inner under-plating layer 53, an outer top-plating layer 54, an inner top-plating layer 55, and the coating layer 56. The base layer 51 may be formed from a first material, the outer under-plating layer 52 and the inner under-plating layer 53 may be formed from a second material, the outer top-plating layer 54 and the inner top-plating layer 55 may be formed from a third material, and the coating layer 56 may be formed from a fourth material. The outer and inner under-plating layers 52, 53 may be added to the base layer 51 using any known coating deposition method, as desired. The outer and inner top-plating layers 54, 55 may then be added over the outer and inner under-plating layers 52, 53 in a secondary deposition process using any known coating deposition method, as desired. The addition of the layers 52, 53, 54, 55 may preferably be performed prior to the assembly of the remainder of the thermal fuse 10. The coating layer 56 may be added to the casing wall 30 prior to the assembly of the thermal fuse 10 or following the assembly of the thermal fuse 10, as desired. If the coating layer 56 is added after the assembly of the thermal fuse 10, the coating layer 56 may only be added to those portions of the casing wall 30 exposed to the ambient environment, as desired. As such, in contrast to the plating layers 52, 53, 54, 55, the coating layer 56 is only coated on the outermost surface of the casing wall 30.

The selection of each of the materials forming the base layer 51, the outer and inner under-plating layers 52, 53, and the outer and inner top-plating layers 54, 55 may be dependent on the operating conditions of the thermal fuse 10 as well as the method of operation of the thermal fuse 10. The layers 51, 52, 53, 54, 55 may be selected to include a desired degree of thermal conduction for allowing the heat energy generated by the clutch slip condition to be transferred to the interior components of the thermal fuse 10. The under-plating and top-plating layers 52, 53, 54, 55 may be selected to provide a desired degree of corrosion resistance, chemical resistance, strength, durability, or electrical conductivity to the casing wall 30, as desired. As explained hereinabove, at least the innermost layer of the casing wall 30 is formed from an electrically conductive material to facilitate the transfer of the current from the slider mechanism 27 to the casing wall 30.

The first, second, and third materials are all preferably thermally conductive metallic materials. The first material forming the base layer 51 may be an electrically and thermally conductive material such as brass, copper, or alloys thereof, as non-limiting examples. According to one embodiment, the base layer 51 is formed from a sheet of high copper C2300R brass. The second material forming the under-plating layers 52, 53 may be an electrically conductive, thermally conductive, and corrosion resistant material such as copper, nickel, or alloys thereof, as non-limiting examples. The third material forming the top-plating layers 54, 55 may be a thermally and electrically conductive material. The third material may be a highly electrically conductive precious metal such as silver, gold, or platinum. Because the third material forms the innermost surface of the casing wall 30, the highly electrically conductive material may be selected for the top-plating layers 54, 55 to facilitate the transfer of the current through the casing wall 30 for electrically coupling the first lead 12 to the second lead 14. Generally, the materials forming the layers 51, 52, 53, 54, 55 of the casing wall 30 may be selected to form a stable electrical system for transferring a current through the thermal fuse 10.

Although described as being formed from metallic materials, one or more of the layers 51, 52, 53, 54, 55 may alternatively be formed from a non-metallic material having the requisite thermal and/or electrical conductivity for operating the thermal fuse 10 as disclosed herein, such as graphite. In some embodiments, the non-metallic material may be formed as an alloy with an impregnated metallic material, such as an alloy formed from the combination of the graphite and one of bronze or copper, as non-limiting examples.

In one non-limiting example, the base layer 51 is about 0.25 mm thick, each of the under-plating layers 52, 53 is about 1.5-3.0 μm thick, and each of the top-plating layers 54, 55 is about 0.4-2.0 μm. However, each of the disclosed layers 51, 52, 53, 54, 55 may have any desired thickness without necessarily departing from the scope of the present invention. A thickness of the casing wall 30 or each individual layer 51, 52, 53, 54, 55 may be selected to ensure that the casing wall 30 or corresponding layer 51, 52, 53, 54, 55 does not provide an undesired degree of thermal resistance to the heat energy transferred therethrough while also maintaining a desired electrical resistance to the current passing through the casing wall 30.

The coating layer 56 is formed from a material having a greater emissivity than the adjacent layer of the casing wall 30 formed inwardly therefrom, and may include a greater emissivity than any of the other materials forming the casing wall 30. In the illustrated embodiment, the coating layer 56 is disposed adjacent the outer top-plating layer 54, hence the coating layer 56 includes an emissivity greater than that of the outer top-plating layer 54. The coating layer 56 may include an emissivity greater than about 0.5 on a 0.0-1.0 scale. More specifically, the coating layer 56 may include an emissivity of about 0.8 or greater. In some embodiments, the emissivity greater than 0.8 may represent a surface having a substantially black appearance, as desired.

The coating layer 56 may be formed or deposited on the casing wall 30 by one of a variety of different processes. According to a first embodiment, the coating layer 56 may be a chemical conversion coating applied to an outermost layer of the casing wall 30 (the outer top-plating layer 54), and more particularly a black chemical conversion coating having an emissivity of 0.8 or greater. The chemical conversion coating may be formed to be relatively thin (<1 μm thick). The chemical conversion coating may form an inorganic reaction product, an intermetallic material, a metal oxide, a metal sulfide, or an other metal reaction product, as desired. The chemical conversion coating may be a black oxide, a black chromate conversion coating, or a phosphate conversion coating. The chemical conversion coating may be formed during an anodizing process.

The type of reaction product produced is dependent on the chemistry of the material or materials used to form the chemical bath used in the conversion process. For the purposes of the present invention, it is understood that any form of chemical conversion process suitable for increasing the emissivity of the exposed surface of the casing wall 30 while maintaining suitable heat exchange and corrosion resistant properties may be utilized without necessarily departing from the scope of the present invention.

According to a second embodiment of the invention, the coating layer 56 may be formed by a vapor deposition method. The vapor deposition method may be a chemical vapor deposition (CVD) method or a physical vapor deposition (PVD) method. The resulting coating layer 56 may be relatively thin (<1 μm thick) and may include an emissivity of 0.8 or greater. The material deposited may be a ceramic coating or a carbon coating. If a ceramic coating is used, the ceramic may be a compound including a combination of a metal and at least one metalloid or at least one non-metal. The metalloid or non-metal may be one of boron, carbon, nitrogen, oxygen, fluorine, silicon, phosphorous, sulfur, chlorine, arsenic, selenium, bromine, tellurium, iodine, lanthanum, cerium, praseodymium, astatine, or combinations thereof.

According to a third embodiment of the invention, the coating layer 56 is formed from an electrically conductive carbon paint or an electrically conductive enamel coating. The carbon paint or the enamel coating may be provided with an emissivity of 0.8 or greater and may be formed to be about 5 μm or greater in thickness.

Accordingly to a fourth embodiment of the invention, the coating layer 56 may be formed from an electrically non-conductive black organic paint coating. The black organic paint coating may be provided with an emissivity of 0.8 of greater and may be formed to be about 15 μm or greater in thickness.

The increased emissivity of the coating layer 56 in comparison to the relatively low emissivity outer top-plating layer 54 increases a heat transfer efficiency of the thermal fuse 10 when encountering thermal radiation generated exterior to the casing wall 30 of the thermal fuse 10, thereby reducing the time required for the thermal fuse 10 to determine that the clutch slip condition has occurred. The thermal fuse 100 can accordingly react to the clutch slip condition in a relatively short time period regardless of the ambient air temperature or engine condition.

During normal operation of the associated electromagnetic clutch assembly, the current used to power the associated electromagnetic coil normally passes through the thermal fuse 10 when the thermal fuse 10 is in the configuration shown in FIG. 4 wherein the current can pass through each of the first lead 12, the slider mechanism 27, the casing wall 30, and then the second lead 14. If a clutch slip condition occurs, the frictional forces present between the associated clutch disc and pulley will generate heat energy that can be transferred to the thermal fuse 10 by any of conductive heat transfer, convective heat transfer, and thermal radiation heat transfer. The heat energy encountering the casing wall 30 is transferred therethrough and to the internal components of the thermal fuse 10. Specifically, the thermal pellet 40 disposed within the casing wall 30 is configured to melt when reaching a preselected temperature indicative of the occurrence of the clutch slip condition exterior to the thermal fuse 10. The thermal pellet 40 may accordingly be formed from a material having a melting temperature substantially equal to the preselected temperature.

FIG. 6 illustrates the thermal fuse 10 following a period of exposure to the clutch slip condition wherein the thermal pellet 40 has reached the preselected temperature and has accordingly melted to an extent wherein the second disk 7 can pass though the at least partially liquefied thermal pellet 40. The melting of the thermal pellet 40 accordingly allows for a repositioning of each of the first spring 4, the slider mechanism 27, the first disk 5, the second spring 6, and the second disk 7 relative to the original position of the thermal pellet 40.

The aforementioned repositioning includes the slider mechanism 27 spaced from the end of the first lead 12. The new position of the slider mechanism 27 is determined by a configuration of each of the first and second springs 4, 6 wherein the corresponding spring forces acting on the slider mechanism 27 by the first and second springs 4, 6 are equalized. The spacing of the slider mechanism 27 from the first lead 12 causes the current passing through the first lead 12 to no longer pass through the slider mechanism 27, the casing wall 30, and the second lead 14, thereby discontinuing the passage of the current from the associated power source to the electromagnetic coil of the electromagnetic clutch assembly. The activation of the thermal fuse 10 accordingly leads to the clutch disc no longer being in frictional engagement with the rotating pulley, thereby ceasing the clutch slip condition.

As explained hereinabove, it should be apparent to one skilled in the art that the internal structure of the thermal fuse 10 may be reconfigured to a plurality of different suitable configurations for ceasing the passage of the current through the thermal fuse 10 without necessarily departing from the scope of the present invention. For example, any suitable assembly of internal components of the thermal fuse 10 wherein the melting of a thermal pellet similar to that shown and described in FIGS. 4 and 6 causes the separation of two current carrying components may be used without departing from the scope of the present invention. One skilled in the art should further appreciate that any component or material suitable for undergoing a predictable structural change in reaction to the reception of thermal energy may be used for forming the internal components of the thermal fuse 10. For example, a component may be selected that undergoes a desired degree of thermal expansion for causing a structural change within the thermal fuse 10 as opposed to melting, as one non-limiting example. Additionally, any sensing mechanism capable of ascertaining a temperature thereof may be utilized within the casing wall 30 for aiding in activating the thermal fuse 10.

The thermal fuse 10 may accordingly be described as including a casing wall configured for transferring the heat generated as a result of the clutch slip condition therethrough and to a thermally activated device disposed within the casing wall, wherein the thermally activated device is configured for activation as a preselected temperature indicative of the occurrence of the clutch slip condition. The inclusion of the coating layer on what would otherwise form the outermost surface of the casing wall aids reducing the amount of time required for activating the thermally activated device disposed within the casing wall.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A thermal fuse comprising:
a casing wall configured to transfer heat energy generated exterior to the casing wall to an interior of the casing wall, the casing wall including a coating layer disposed on an adjacent layer, the coating layer forming an outermost surface of the casing wall and having an emissivity greater than the adjacent layer of the casing wall.

2. The thermal fuse of claim 1, further comprising a thermally activated device disposed in the interior of the casing wall, the thermally activated device configured for activation at a preselected temperature.

3. The thermal fuse of claim 1, wherein the coating layer has an emissivity of 0.8 or greater.

4. The thermal fuse of claim 1, wherein the coating layer is formed by a chemical conversion process applied to the adjacent layer of the casing wall.

5. The thermal fuse of claim 4, wherein the chemical conversion process produces a coating layer formed from a compound including a metal and an inorganic.

6. The thermal fuse of claim 1, wherein the coating layer is formed by a vapor deposition process.

7. The thermal fuse of claim 1, wherein the coating layer is formed by a compound including a combination of a metal and one of a metalloid or a non-metal.

8. An electromagnetic clutch assembly comprising:
a pulley;
a clutch disc configured to selectively engage the pulley; and
a thermal fuse including:
a casing wall configured to transfer heat generated exterior to the casing wall as a result of relative frictional motion between the pulley and the clutch disc to an interior of the casing wall, the casing wall including a coating layer disposed on an adjacent layer, the coating layer forming an outermost surface of the casing wall and having an emissivity greater than the adjacent layer of the casing wall.

9. The electromagnetic clutch assembly of claim 8, wherein the thermal fuse further includes a thermally activated device disposed in the interior of the casing wall, the thermally activated device configured for activation at a preselected temperature.

10. The electromagnetic clutch assembly of claim 8, wherein the coating layer has an emissivity of 0.8 or greater.

11. The electromagnetic clutch assembly of claim 8, wherein the coating layer is formed by a chemical conversion process applied to the adjacent layer of the casing wall.

12. The electromagnetic clutch assembly of claim 11, wherein the chemical conversion process produces a coating layer formed from a compound including a metal and an inorganic.

13. The electromagnetic clutch assembly of claim 8, wherein the coating layer is formed by a vapor deposition process.

14. The electromagnetic clutch assembly of claim 8, wherein the coating layer is formed by a compound including a combination of a metal and one of a metalloid or a non-metal.

15. A method of manufacturing a thermal fuse comprising the steps of:
providing the thermal fuse having a casing wall including an outermost layer, the casing wall configured to transfer heat generated exterior to the casing wall to a thermally activated device disposed in an interior of the casing wall; and
forming or depositing a coating layer on the outermost layer of the casing wall, the coating layer having an emissivity greater than the outermost layer of the casing wall.

16. The method of claim 15, wherein the coating layer is formed during a chemical conversion process applied to the outermost layer of the casing wall.

17. The method of claim 16, wherein the outermost layer is formed from a metal, and wherein the coating layer is formed from a compound including a combination of the metal and an inorganic.

18. The method of claim 15, wherein the coating layer is deposited on the outermost layer of the casing wall during a vapor deposition process.

19. The method of claim 18, wherein the coating layer is formed from a compound including a combination of a metal and one of a metalloid or a non-metal.

20. The method of claim 15, wherein the coating layer is painted onto the outermost layer of the casing wall.
